(19) United States
(12) Patent Application Publication
(10) Pub. No.: US 2023/0303899 A1
(43) Pub. Date: Sep. 28, 2023

(54) PHOSPHATE-CONTAINING BIOMIMETIC POLYMERS AND USES THEREOF

(71) Applicant: Purdue Research Foundation, West Lafayette, IN (US)

(72) Inventors: Jonathan J. Wilker, West Lafayette, IN (US); Taylor A. Jones, Sandy Springs, GA (US)

(73) Assignee: Purdue Research Foundation, West Lafayette, IN (US)

(21) Appl. No.: 18/023,334

(22) PCT Filed: Sep. 3, 2021
(86) PCT No.: PCT/US2021/048983

§ 371 Date: Feb. 24, 2023

Related U.S. Application Data
(60) Provisional application No. 63/073,959, filed on Sep. 3, 2020.

(51) Int. Cl. C09J 143/02

(52) U.S. Cl. CPC C09J 143/02

(57) ABSTRACT

This invention relates to a method for increasing wetting capability of a biomimetic polymer adhesive comprising the step of introducing plurality of phosphate moieties into said biomimetic polymer adhesive. In particular, the present disclosure relates a method to manufacture a biomimetic polymer adhesive with an increased wetting capability by inducing plurality of phosphate moieties by copolymerization of phosphate-containing monomer, such as monoacryloxyethyl phosphate (MAEP), together with other monomers, or by way of post-polymerization chemical derivertizations. The process and the product thereof are within the scope of this disclosure.

### CROSS-REFERENCE TO RELATED APPLICATIONS

The present U.S. patent application relates to and claims the priority benefit of U.S. Provisional Patent Application Ser. No. 63/073,959, filed Sep. 3, 2020, the contents of which are hereby incorporated by reference in its entirety into this disclosure.

### GOVERNMENT RIGHTS

This invention was made with government support under N000141612709 and N000141912342, awarded by the Office of Naval Research. The government has certain rights in the invention.

### TECHNICAL FIELD

This invention relates to phosphate-containing biomimetic copolymers as an adhesive and a method for increasing the surface wetting capability of biomimetic copolymers. Methods and composition matters are within the scope of this disclosure.

### BACKGROUND AND SUMMARY OF THE INVENTION

This section introduces aspects that may help facilitate a better understanding of the disclosure. Accordingly, these statements are to be read in this light and are not to be understood as admissions about what is or is not prior art.

Marine organisms employ an array of strategies for attaching to surfaces in the seas. A common theme is adhesion with proteins. Modified amino acid residues, including phosphoserines and hydroxylated tyrosines, are common in bioadhesives.¹⁻⁶ Sandcastle worm glue, for example, has serines that are almost entirely phosphorylated.^{5,7} This protein system also contains 3,4-dihydroxyphenylalanine (DOPA) residues for cross-linking and well established adhesion chemistry. Mussel adhesives incorporate a wide mix of modified amino acids including hydroxylated arginine, proline, and tyrosine.⁸⁻¹⁴ Phosphoserines are present in some mussel adhesive proteins but only at low levels (2-5%) of all amino acids and are less prevalent than DOPA (2-30%).^{10, 11, 13-15}

Underwater adhesion is a generally difficult goal to achieve. Man-made glues are not good at penetrating surface-bound waters in order to make strong contact with substrates. Monomers, oligomers, polymers, and proteins also often interact with water, thereby inhibiting the needed cohesive forces. Work with biomimetic polymers has shown that, at the simplest level, all that is required for strong underwater bonding is a high molecular weight polymer with pendant catechol groups.^{16, 17} Why do bioadhesive proteins have such relatively complex functionalities if the desired core function can be achieved with simpler systems?¹⁶⁻²⁶ At this point, synthetic polymers remain limited in some desirable traits when compared to natural systems. Live mussels deposit their proteins from aqueous gels or foams whereas biomimetic polymers often require the use of organic solvents to enable application. If water soluble, biomimetic polymers face the challenge of not dissipating into the surroundings when applied underwater.

Most mussel adhesive proteins are positively charged, with cationic amino acids far outnumbering anionic residues.^{8,11,27,28} Positive charges have been proposed to increase surface attachment by displacing bound cations, thereby fostering interfacial contacts.^{8,29} Previous findings have also noted that, when in moderation, positive charge can enhance bulk adhesion.³⁰ Small amounts of positive charge helped joining of substrates under seawater whereas cation loadings that were too high appeared detrimental to the bulk bonding.³⁰ With dry conditions, adding positive charge to a catechol-containing polymer showed a mild decrease in performance.³⁰ Positive charges have also been seen to influence it-stacking and contribute to cation-π interactions.^{9, 31-33} Such bonding may be present cohesively in the bulk as well as taking place at surfaces.

Complex coacervates are liquid-liquid phases generated by the combination of oppositely charged molecules.^{2, 3} This phase separation ejects excess water and ions from the bulk.^{3, 7} The result can be a high surface energy system that flows separately from surrounding water and binds well to inorganic surfaces. Sandcastle worms combine their polyanionic phosphorylated proteins with cations to generate a complex coacervate adhesive.^{2, 4-7, 34-36} Coacervates have also been suggested to be present in mussel adhesive, based upon the variety of negative and positive charges seen in proteins.^{32, 37} Mimics of sandcastle worms derived from acrylic phosphate polymers exhibit impressive underwater binding abilities.^{2, 5, 38} Sea stars are yet another example of a marine organism employing phosphorylated proteins for adhesion in challenging environments.^{1, 39}

Phosphates are used commonly for inhibiting corrosion in industrial metal production.⁴⁰ The metal chelating and also acid etching properties of phosphates or phosphoric acid are beneficial with inorganic surfaces. Steel is particularly well suited to phosphate passivation. The amphoteric nature of phosphate and the ability to interact with varying protonation states of surface hydroxides or oxides create beneficial interactions.⁴⁰ Sulfonates and other anionic salts are also good surface modifiers. Phosphate monomers have been placed within polymeric industrial glues and ion-exchange resins for increasing metal binding.⁴¹ The inorganic nature of phosphate finds further uses in fire retardancy.²⁵ Biomedical materials used for the replacement or supplementation of bone often contain phosphate groups, given the composition of hydroxyapatite, (Ca₅(PO₄)₃OH).⁴²

As far as we know, the effects of anions on bulk adhesion are still not understood well. Systematic structure-function studies are needed to determine the potential effects of phosphates on the performance of biomimetic adhesives. Here, a family of polymers, referred to as poly(catechol-phosphates), was made with catechol to provide adhesion and a range of different loadings for the monomer containing phosphate functional groups. This acrylate-based system demonstrated significant dry and some underwater adhesion with modest dependencies upon the amount of phosphate that was present.

### BRIEF DESCRIPTION OF THE DRAWINGS

FIG. 1 shows the structure of the poly(catechol-phosphate) family of terpolymers. The catechol-containing monomer (red) was held at about 12-19% with phosphate (blue) between 2-26% and MMA (black) comprising the remainder.

FIGS. 2A-2C depict polymer solutions and wetting of stainless steel substrates after curing. Each piece of steel was 1.2×8.8 cm. Overlap area was 1.2×1.2 cm. FIG. 2A. Control polymer solution without phosphates. This solution remained only where placed between the two adherends. Viewed after being pulled apart for adhesion testing. FIG. 2B shows from a polymer with 17% of the phosphate-containing monomer. Note how the solution spread out beyond where placed between the substrates. This image was taken after testing the joint for adhesion strength. FIG. 2C shows side view of two steel substrates after curing, but before pulling apart. Note how the polymer, only deposited between pieces of steel, crept up the metal side.

FIG. 3 shows dry adhesion with poly(catechol-phosphate) as a function of phosphate functional groups in the polymer. Lap shear joints were made between steel substrate and pulled apart until failure to yield adhesion values.

FIGS. 4A-4B depict polymer applied to steel under different types of water. Samples shown after pulling the joints apart for bond strength testing. Each substrate was 1.2 cm wide. FIG. 4A shows deionized water with poly(catechol-phosphate). FIG. 4B shows salt water with poly(catechol-phosphate). Apparent color differences were influenced by the lighting.

FIGS. 5A-5B show ¹H (FIG. 5A) and ³¹P (FIG. 5B) NMR spectra for poly[N-(3,4-dihydroxyphenethyl)methacrylamide)-co-methyl methacrylate-co-(monoacryloxy ethyl phosphate)], “poly(catechol-phosphate).”

FIG. 6 shows ¹H NMR spectrum of poly[N-(3,4-dihydroxyphenethyl) methacrylamide)-co-methyl methacrylate].

FIG. 7 shows the force-versus-extension plots for several derivatives of poly(catechol-phosphate) from adhesion measurements.

FIGS. 8A-8D show the side views for solution droplets of polymers on steel (FIG. 8A) and Teflon (FIG. 8B) surfaces, as compared with the corresponding control (no phosphate, FIGS. 8C and 8D, respectively). Each drop was ˜5 μL.

### DETAILED DESCRIPTION

For the purposes of promoting an understanding of the principles of the present disclosure, reference will now be made to the embodiments illustrated in the drawings, and specific language will be used to describe the same. The following detailed description is of the best currently contemplated modes of carrying out the disclosure. The description is not to be taken in a limiting sense, but is made merely for the purpose of illustrating the general principles of the disclosure, since the scope of the disclosure is best defined by the appended claims.

As used herein, the following terms and phrases shall have the meanings set forth below. Unless defined otherwise, all technical and scientific terms used herein have the same meaning as commonly understood to one of ordinary skill in the art.

In the present disclosure the term “about” can allow for a degree of variability in a value or range, for example, within 20%, within 10%, within 5%, or within 1% of a stated value or of a stated limit of a range.

In the present disclosure the term “substantially” can allow for a degree of variability in a value or range, for example, within 80%, within 90%, within 95%, or within 99% of a stated value or of a stated limit of a range.

In this document, the terms “a,” “an,” or “the” are used to include one or more than one unless the context clearly dictates otherwise. The term “or” is used to refer to a nonexclusive “or” unless otherwise indicated. In addition, it is to be understood that the phraseology or terminology employed herein, and not otherwise defined, is for the purpose of description only and not of limitation. Any use of section headings is intended to aid reading of the document and is not to be interpreted as limiting. Further, information that is relevant to a section heading may occur within or outside of that particular section. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

Certain embodiments of the present disclosure may be better understood through the following non-limiting examples.

In some illustrative embodiments, the present disclosure relates to a method for increasing surface wetting capability of a biomimetic polymer adhesive comprising the step of introducing a plurality of phosphate moieties into said biomimetic polymer adhesive.

In some illustrative embodiments, the present disclosure relates to a method for increasing surface wetting capability of a biomimetic polymer adhesive as disclosed herein, wherein said biomimetic polymer adhesive is a catechol-containing polymer or co-polymer.

In some illustrative embodiments, the present disclosure relates to a method for increasing surface wetting capability of a biomimetic polymer adhesive as disclosed herein, wherein said plurality of phosphate moieties are introduced into said biomimetic polymer adhesive by way of copolymerization of monoacryloxyethyl phosphate (MAEP) together with other monomers.

In some illustrative embodiments, the present disclosure relates to a method for increasing surface wetting capability of a biomimetic polymer adhesive as disclosed herein, wherein said plurality of phosphate moieties are introduced into said biomimetic polymer adhesive by way of chemical derivatization of a polymer or copolymer.

In some illustrative embodiments, the present disclosure relates to a method for increasing surface wetting capability of a biomimetic polymer adhesive as disclosed herein, wherein said biomimetic polymer adhesive with an increased surface wetting capability is useful for dry bonding or underwater wet bonding.

In some illustrative embodiments, the present disclosure relates to a method for increasing surface wetting capability of a biomimetic polymer adhesive as disclosed herein, wherein said biomimetic polymer adhesive with an increased surface wetting capability is useful for bonding on a metal surface.

In some illustrative embodiments, the present disclosure relates to a method for increasing surface wetting capability of a biomimetic polymer adhesive as disclosed herein, wherein said plurality of phosphate moieties accounts for from about 0.1% to about 50% of the whole copolymer.

In some other illustrative embodiments, the present disclosure relates to a biomimetic polymer adhesive having an increased surface wetting capability, wherein said biomimetic polymer adhesive comprises a catechol-containing polymer or co-polymer with a plurality of phosphate moieties.

In some other illustrative embodiments, the present disclosure relates to a biomimetic polymer adhesive having an increased surface wetting capability as disclosed herein, wherein said plurality of phosphate moieties accounts for from about 0.1% to about 50% of the total biomimetic polymer adhesive.

In some other illustrative embodiments, the present disclosure relates to a biomimetic polymer adhesive having an increased surface wetting capability as disclosed herein, wherein said biomimetic polymer adhesive is a catechol-containing polymer or copolymer.

In some other illustrative embodiments, the present disclosure relates to a biomimetic polymer adhesive having an increased surface wetting capability as disclosed herein, wherein said plurality of phosphate moieties are introduced into said biomimetic polymer adhesive by way of copolymerization of monoacryloxyethyl phosphate (MAEP) with other monomers.

In some other illustrative embodiments, the present disclosure relates to a biomimetic polymer adhesive having an increased surface wetting capability as disclosed herein, wherein said biomimetic polymer adhesive with an increased wetting capability is useful for dry bonding or underwater wet bonding.

In some other illustrative embodiments, the present disclosure relates to a biomimetic polymer adhesive having an increased surface wetting capability as disclosed herein, wherein said biomimetic polymer adhesive with an increased wetting capability is useful for bonding on a metal surface.

In some other illustrative embodiments, the present disclosure relates to a biomimetic polymer adhesive having an increased surface wetting capability as disclosed herein, wherein said biomimetic polymer adhesive are useful as a paint, surface coating, or a primer.

In some yet other illustrative embodiments, the present disclosure relates to a product of biomimetic polymer adhesive having an increased surface wetting capability as disclosed herein.

In some other illustrative embodiments, the present disclosure relates to a process for manufacturing a biomimetic polymer adhesive having an increased surface wetting capability comprising the steps of
a) mixing DMA (dopamine methacrylamide), MMA (methyl methacrylate), and monoacryloxyethyl phosphate monomers in a solvent to give a mixture;
b) adding an initiator of polymerization to said mixture under a constant stirring to trigger said polymerization;
c) quenching said polymerization; and
d) removing said solvent to afford said biomimetic copolymer adhesive having an increased wetting capability.

In some other illustrative embodiments, the present disclosure relates to a process for manufacturing a biomimetic polymer adhesive having an increased surface wetting capability manufactured according to the steps as disclosed herein, wherein said monomers have a molar ratio about 3:6:1.

In some other illustrative embodiments, the present disclosure relates to a process for manufacturing a biomimetic polymer adhesive having an increased surface wetting capability manufactured according to the steps as disclosed herein, wherein said biomimetic polymer adhesive with an increased wetting capability is useful for dry bonding or underwater wet bonding.

In some other illustrative embodiments, the present disclosure relates to a process for manufacturing a biomimetic polymer adhesive having an increased surface wetting capability manufactured according to the steps as disclosed herein, wherein said biomimetic polymer adhesive with an increased wetting capability is useful for bonding on a metal surface.

In some other illustrative embodiments, the present disclosure relates to a process for manufacturing a biomimetic polymer adhesive having an increased surface wetting capability manufactured according to the steps as disclosed herein, wherein said plurality of phosphate moieties accounts for from about 0.1% to about 50% of the whole copolymer.

In some other illustrative embodiments, the present disclosure relates to a process for manufacturing a biomimetic polymer adhesive having an increased surface wetting capability manufactured according to the steps as disclosed herein, wherein said biomimetic polymer adhesive are useful as a paint, surface coating, or a primer.

In some other illustrative embodiments, the present disclosure relates to a product of a biomimetic polymer adhesive having an increased surface wetting capability manufactured according to the steps as disclosed herein.

Bioadhesives are popular characterization targets for informing the design of synthetic materials. Many naturally occurring adhesive proteins are phosphorylated, yet we do not know why phosphorylation might be so prevalent in nature. Here phosphate-containing biomimetic polymers were made using the chemistry of catechol, or 3,4-dihydroxyphenylalanine (DOPA), for adhesion. Structure-function studies were carried out with this family of poly(catechol-phosphate) polymers to determine how phosphate groups influence bulk adhesion. Bonding was studied both dry and underwater. Under some conditions polymers containing phosphate groups exhibited extreme levels of surface wetting on steel substrates. Dry adhesion increased moderately with greater phosphate content in the polymers. Underwater bonding was weaker than dry and achieved, only to a limited degree, when the polymer phosphate content was high. These results indicate that phosphates may provide an aid to the more impactful adhesive properties of catechols. Such insights may also help to explain the existence of phosphates in bioadhesives as well as inform the future design of high performance materials.

### Results and Discussion

Initial efforts for adding phosphate groups to a catechol-containing polymer began with an established polystyrene-based system, poly(catechol-styrene).^{21, 53} This starting point was a logical choice given that such a mussel mimicking system has shown some of the highest performance amongst recent biomimetic adhesives. Direct phosphorylation of catecholic hydroxyl groups (i.e., Ar—OPO(OH)₂)) could work but was generally inconsistent and several byproducts were made.⁵⁵ We could obtain the desired phosphorylated poly(catechol-styrene), although the phosphates did not remain on the polymers for sufficient times. Phosphate groups with an aromatic oxygen are often susceptible to hydrolysis.⁵⁶ A modified Michaelis-Arbuzov reaction was used to create phosphonate versions of the adhesive copolymers (i.e., R—PO(OH)²).^{57, 58} When compared to phosphates, phosphonates are more resistant to hydrolysis, have similar structures, roughly similar pKa's, can be ionic, and are obtained via somewhat straightforward synthetic pathways.²⁶ Despite success in the synthesis of phosphonate functional group containing polymers, strong adhesion was not observed.

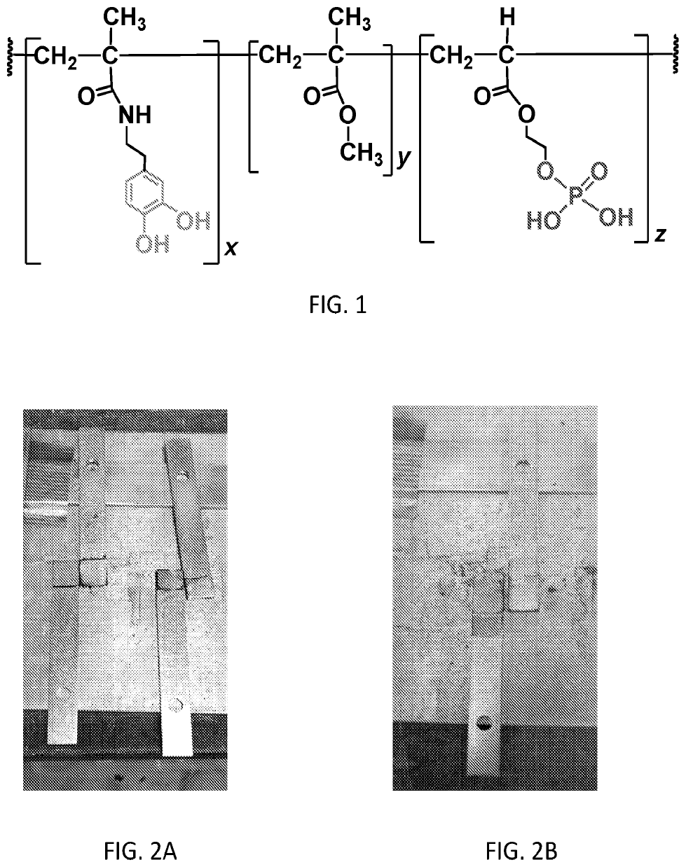

In order to obtain insights on how true phosphate groups may influence adhesion, we turned to acrylic polymers containing catechols. Literature precedent showed that such materials are synthetically accessible.^{2, 5, 26, 47, 48, 59, 60} FIG. 1. depicts the general structure of these target terpolymers. The percentage of the phosphate monomer within the polymer was varied while the catechol content remained roughly constant at ˜12-29%. Methyl methacrylate (MMA) accounted for the remainder.

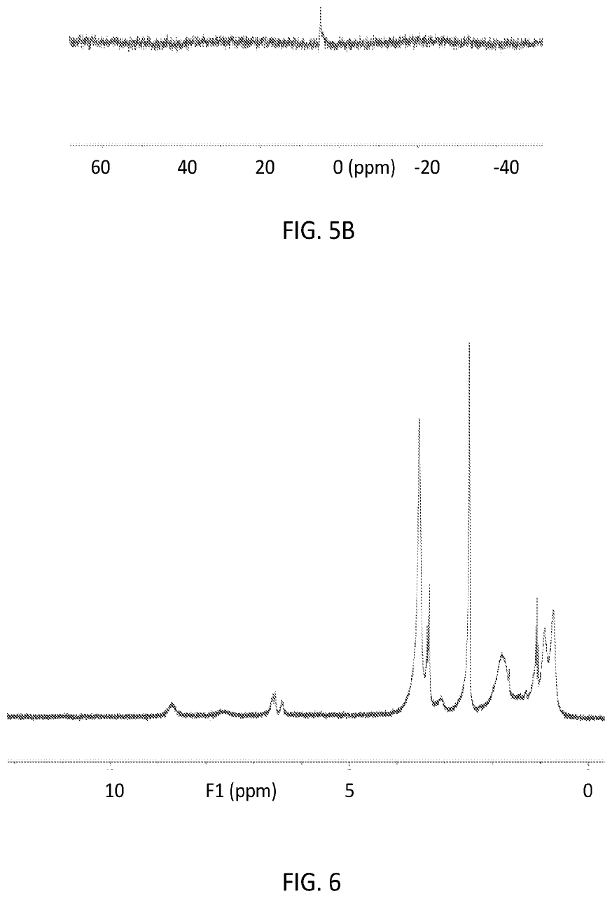

Target terpolymers were obtained by combining all three monomers with the AIBN radical initiator, solvent, and heat. This one pot polymerization was followed by an easy workup that yielded clean polymers with little or no unreacted monomer impurities seen spectroscopically. The final polymers were soluble in common solvents including methanol and N,N-dimethylformamide (DMF). Characterization data from ¹H NMR spectroscopy, ³¹P NMR spectroscopy, and gel permeation chromatography (GPC) were straightforward to interpret (FIGS. 5-6). More challenging, however, was inconsistency between ratios of monomers in the feed and what was found in the end polymer compositions. Even though monomer feed ratios were held relatively constant, different final polymer percentages were produced from each synthesis. Multiple synthetic runs with catechol:MMA:phosphate ratios of 2.6:5.6:1.4 yielded polymers with final ratios ranging from, for example, 7.4:90:2.3 to 19:55:26. Consequently, the target family of polymers with varying phosphate loadings was obtained by repeating the synthesis at the same starting ratio until a suitable array of derivatives was made. When a given synthesis yielded a polymer that was outside a usable range or too close to what was already in hand another polymerization was carried out. Table 1 shows final characterization data for the nine polymers used for these structure-function studies.

Catechol content of the polymers was held as constant as practical. All polymers had between 12% and 19% of the catechol-containing dopamine methacrylamide monomer, with one exception at 7.4%. Earlier results showed that differing catechol loadings in a polymer can influence adhesive performance.²⁰ Nonetheless, monomers containing catechol functional groups within the ˜12-19% range exhibited similar adhesion.²⁰

TABLE 1
Characterization data for derivatives of poly (catechol-phosphate).

| Phosphate | Catechol | MMA | M_{w} | Dispersity |
|---|---|---|---|---|
| % (MAEP) | % (DMA) | % | (g/mol) | (Ð) |
| 26.0 | 19.0 | 55.0 | 6,200 | 1.3 |
| 24.0 | 15.0 | 61.0 | 4,600 | 1.5 |
| 23.0 | 19.0 | 58.0 | 6,200 | 1.6 |
| 22.0 | 19.0 | 59.0 | 5,800 | 2.1 |
| 18.0 | 13.0 | 69.0 | 4,600 | 1.7 |
| 17.0 | 15.0 | 68.0 | 5,600 | 1.6 |
| 15.0 | 12.0 | 73.0 | 4,900 | 1.7 |
| 13.0 | 16.0 | 71.0 | 4,800 | 1.5 |
| 8.0 | 19.0 | 73.0 | 8,800 | 1.3 |
| 2.3 | 7.4 | 90.4 | 7,800 | 1.4 |
| 0 | 13.4 | 86.6 | 3,300 | 2.5 |

The phosphate monomer can be viewed as a derivative of methyl acrylate whereas the other two monomers are either methyl methacrylate or a version thereof. The known reactivities of methyl acrylate (r≈1.04) and methyl methacrylate (r≈2.2) are close enough that random or statistical copolymers may result from the monomer feeds used here.⁶¹ The maximum achievable loading of the phosphate functional group was 26%. Attempted syntheses with greater degrees of phosphates were unsuccessful, primarily from precipitation from solution during the polymerization reactions. Obtaining this array of polymers with a range of phosphate contents, relatively consistent catechol loadings, and similar molecular weights required twenty syntheses.

All polymers made using this synthetic procedure showed fairly low molecular weights (Mw's) in the ˜3,000-8,000 gram/mole range. Prior work has shown that adhesion of catechol-containing polymers begins to rise when Mw values start at ˜20,000 grams/mole and go higher.¹⁸ Consequently, all of the polymers reported here may have similar performance with regard to potential effects from molecular weights.

Solvents used in the polymerization reactions could have influenced molecular weights here. Methanol was used most often. When switching to DMF for an alternative, molecular weights remained low. Catechols can, in general, be antioxidants and radical inhibitors.⁶² Thus quenching of the radical polymerization by the catechol-containing dopamine methacrylamide (DMA) monomer may be, at least partially, responsible for the low molecular weights found here. We did consider, briefly, protecting the catechol groups prior to polymerization and deprotection reactions afterwards. However, we have found that studying families of polymer derivatives for adhesion structure-function studies becomes quite impractical when the synthetic procedures are too long, adding years to projects.^{30, 63} Prior work with the monoacryloxyethyl phosphate (MAEP) monomer showed homopolymers of molecular weights near 8,000 g/mol and copolymers up to 20,000 g/mol.²⁴ All adhesion experiments reported here included addition of tetrabutylammonium periodate, [(C₄H₉)₄N](IO₄), which is often used to oxidize and cross-link catechol-containing materials.^{18, 53, 64, 65} Such cross-linking is a crude, albeit easy and effective, means of increasing molecular weights.

Adhesion experiments with poly(catechol-phosphate) began by placing methanol solutions of each polymer atop steel substrates. At this point, some interesting and rather unexpected properties began to emerge with regard to how the polymers interacted with surfaces. FIGS. 8A-8D shows side-on images of a representative polymer with 17% phosphate dissolved in methanol and dropped onto both steel and Teflon substrates, as compared with the corresponding control polymer without phosphates. Contact angles were 17±2° for steel and 35±3° on Teflon. A control polymer with no phosphate yielded values of 31±3° on steel and 40±3° with Teflon. No periodate was added to any of these samples. The same concentration of polymer in solution was used for both these contact angle values (plus images) and adhesion experiments. These data provided the first view of interesting wetting phenomena. The polymer with phosphate functional groups and steel substrate yielded the lowest contact angle, indicating a particularly strong affinity between adhesive and surface.

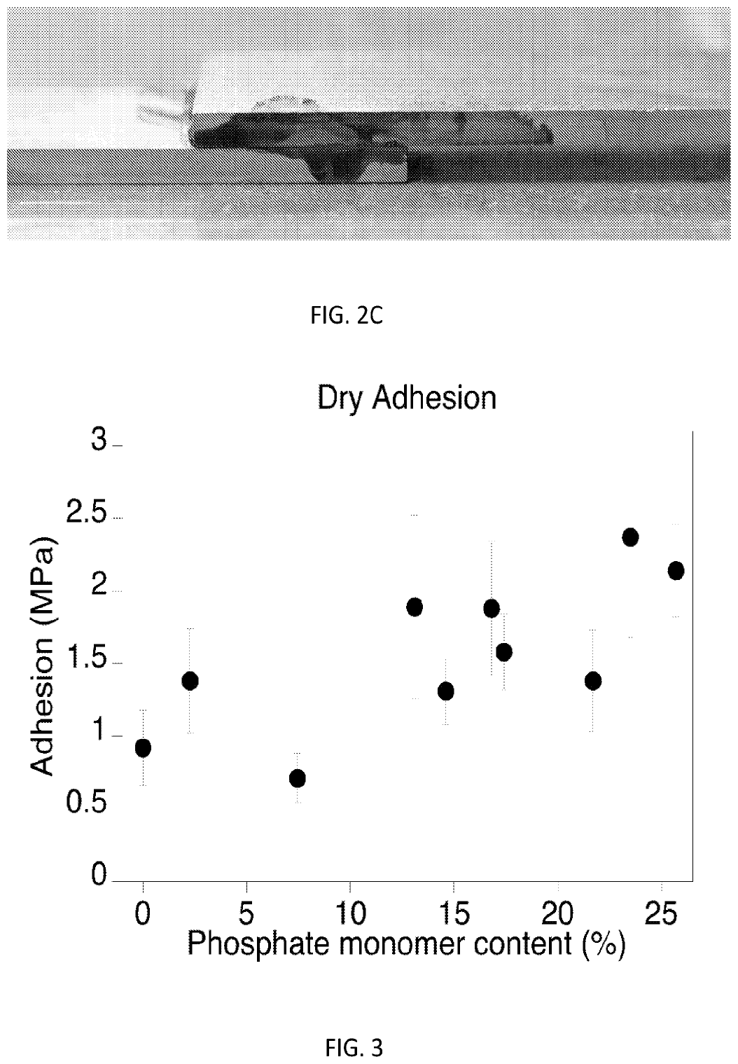

Once the experiments transitioned from deposition atop surfaces to adhesion between substrates, however, more stark differences emerged. Methanol solutions of each polymer were deposited onto steel substrates (20 ml) followed by addition of the cross-linker solution (5 mL), mixing, and then overlap of substrates to form lap shear joints. FIG. 2A shows representative samples after these joints were cured in an oven at 70° C. for 22 hours. Behavior of the control polymer, without phosphate, was typical of all other adhesive systems that we have worked with over the years. Heat from the oven removed solvent and the fully cured polymer resided where it was applied, only among the overlap area between substrates. By contrast, the polymers with phosphate functionality exhibited a type of extreme surface wetting (FIG. 2B). After pulling the two pieces of steel apart, it was apparent that the polymer flowed far beyond only the substrate overlap. These phosphate polymers crept up the substrate outside of the overlap area. Never before have we seen such high affinity of polymers for a surface despite working with several catechol-containing systems. This extreme surface affinity can be seen particularly well in FIG. 2C. Note how the phosphate polymer, in effect, defied gravity by moving up and along the side of the top steel substrate.

These results demonstrate that incorporation of phosphate generated very high affinity of these polymers for steel surfaces. In terms of bulk adhesives requiring both surface attachment and cohesive interactions, it appears that phosphates in a polymer are particularly good at providing the former type of bonding. After this spreading effect was observed, solution volumes for adhesion experiments were decreased to 20 μL (˜6-7 mg of polymer per sample), down from 45 mL, to keep all applied polymer solution within the overlap area between substrates.

Given these observations of extreme surface wetting and the long history of inorganic phosphate (e.g., phosphoric acid) being used to inhibit corrosion, steel substrates became a logical choice for adhesion studies. Dry bonding conditions are more common than wet, easier to work with, and were examined first. The polymers in Table 1, each with a varied amount of phosphate incorporated, were used to bond together two steel substrates into lap sheer joints. FIG. 3 shows the resulting structure-function data in which adhesion is seen as a function of how much phosphate was in the polymer.

The zero phosphate control polymer bonded at ˜1 MPa. In general, we consider 1 MPa to be the lower threshold of high strength adhesion. For the sake of calibration, we often see commercial products such as cyanoacrylate Super Glue and polyvinyl acetate Elmer's Glue-All to adhere under similar conditions at ˜3-11 MPa.^{20, 21} Thus this catechol-containing acrylate provides a good adhesion starting point for testing added functionalities. Performance increased upon addition of phosphates. At the maximum, ˜2.4 MPa was achieved with the composition containing ˜24% phosphate functional groups. This value puts poly(catechol-phosphate) on the lower end of commercial glue performance.

All polymers were cross-linked with the oxidant [(C₄H₉)₄N](IO₄) in adhesion tests. Prior experience with catechol-containing polymers has shown that a 3:1 ratio of catechol:(IO₄)⁻ is often best for achieving high bond strengths. With practical difficulties brought about by the extreme surface wetting of these polymers and steel substrates (FIG. 2), a catechol:(IO₄)⁻ ratio of 4:1 was found to be a little easier to work with here. This small decrease of periodate addition helped prevent more unwanted wetting and made sure that the polymer solution would not over cross-link into an insoluble gel to affect the formation of lap shear joints. When periodate was omitted from the formulations, bond strengths were all significantly lower. The increased effective molecular weights that result from cross-linking may be important for obtaining good performance.¹⁸ FIG. S4 shows typical force-versus-extension curves for each polymer during adhesion testing. In all cases the force rise was rapid with failure (i.e., loss of force) sudden and sharp. These data indicate that, once cured, the polymers were all brittle in nature. Cross-linking with periodate may account for at least part of the observed brittleness.

Beyond raising the bonding capabilities, incorporating more phosphate into the polymer provided a practical benefit. The polymers of higher phosphate content were more soluble in methanol solvent. Several of these polymer variants were tricky to deal with in regard to solubility. For example, polymers with under 10% phosphate were much less soluble in methanol, enough to make dissolution for formulating glues a bit challenging. Sonication and elevated temperatures aided in dissolution. Once there was ˜13% or more of the monomers with the phosphate functionality, the polymers became freely soluble in methanol. Despite seeing a decrease in solubility in methanol at lower percentages, the polymers were still insoluble in chloroform and acetone. Solubility in DMF was always possible. Water solubility was not found for any polymer here, even those with the highest phosphate loading. For permitting direct comparisons of all polymers, using only one solvent was most desirable. A low boiling point also provided a benefit in being able to evaporate easily and leave behind a dried polymer to form a strong joint. Overall, methanol proved to be the most suitable for these studies.

Water interferes with all aspects of adhesion, including both polymer-surface and polymer-polymer interactions. In order to keep things as simple as possible, wet bonding studies began with deionized water and steel substrates at the bottom of a filled tank. The variants of poly(catechol-phosphate) were each dissolved into methanol, placed in a syringe, and held underwater. The polymer solutions were then deposited onto one submerged substrate and the second piece of steel was overlapped to form a lap shear joint. Curing was for 24 hours, at room temperature, and remained underwater. Joints were then removed from the bath and measured for adhesion. Here the full 45 μL of polymer solution was used. With the methanol solvent being miscible in water, the extreme surface wetting became less of a practical concern.

Not surprisingly, obtaining substantial strengths underwater was quite challenging. Most pairs of steel did not remain together when handled, although some joints were robust. All underwater bond strengths were lower than for dry conditions (FIG. 3). The control polymer without any phosphates did not bond at all. When a substrate pair with this control was picked up out of the tank the two pieces of steel fell apart. Likewise, the 8% phosphate polymer also failed to stick. Once higher levels of phosphate were included, a limited degree of adhesion did appear. In a typical experiment with n=5 samples and the 13% phosphate polymer, 2 of 5 samples remained together enough to measure whereas 3 joints failed upon handling. Those two bonds averaged to ˜0.08 MPa. Moving up to 17% phosphate also saw only 2 of 5 joints measurable, averaging to ˜0.13 MPa. Four of five samples could be quantified from 23% of the monomers with phosphate functionality in the polymer and yielded an average of ˜0.10 MPa. With 24% phosphate, again, only 2 of 5 samples were able to be placed into the instrument. The average of these two samples was ˜0.5 MPa. Some trending may be present here in that more bonding and higher strengths were seen when a greater phosphate content was in the polymers. However, achieving the goal of robust underwater adhesion was not evidenced fully. For reference, ˜0.5 MPa can be considered high within the context of bonding underwater.^{16, 17, 66}

Bonding under salt water was, in general, even more difficult to achieve than when working under deionized water. Most polymers did not yield a bond of any measurable strength. Out of the 5 tests per polymer, very few samples stuck. However, at the upper limits of phosphate functionality in the polymer (26%) 2 out of the 5 samples bonded at ˜0.17 MPa. Although salt water decreased performance relative to deionized water, in both cases maximum bonding correlated to the higher phosphate loadings. Prior underwater work with several commercial glues showed that most materials cannot bond at all.¹⁷ Some products were able to join 304 SAE steel substrates under salt water with strengths up to ˜0.2-0.5 MPa.¹⁷ Such glues are marketed specifically for wet bonding applications and encompass urethane, acrylate, and epoxy chemistries.

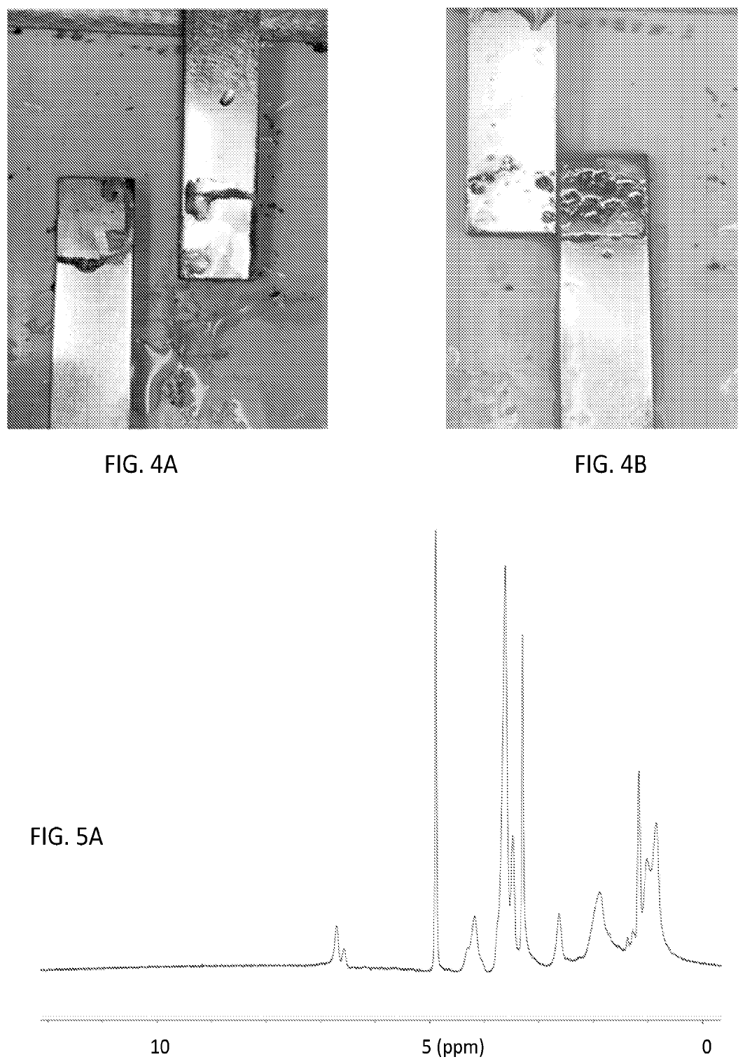

In wondering why adhesion under salt water was less than deionized water, the images of FIG. 4 may be helpful. When solutions of poly(catechol-phosphate) were deposited onto steel under deionized water, a smooth and evenly wetted film resulted. If the same experiment was carried out under sea water an uneven, somewhat chunky mixture of solid and liquid was seen. The very high salt content of the surrounding water (˜3.5 g/L) was likely complexing with the phosphate groups and altering solubility. Also possible was that salt water may have generated a different array of ions bound atop the steel surface versus the dry or under distilled water conditions used here.^{67, 68} Prior studies of anionic metal-oxo surfaces have shown that cations can bind directly and that the identity of these cations can differ, depending upon condition changes.^{67, 68}

Why might phosphate groups aid the adhesion of a polymer? Inorganic phosphate, often used in the H₃PO₄ form of phosphoric acid, has established interactions with steel and other metallic surfaces.⁴¹ The formation of insoluble tertiary phosphates on surfaces protects metals from external corrosion. The exact chemistry of phosphate attaching to steel surfaces is a somewhat complex topic, with several binding modes possible including hydrogen bonding to metal oxides and direct formation of metal-phosphate bonds. Hydrogen bonding can happen with a single or two oxygens from one phosphate, potentially bridging via two protons to two oxygens. Phosphate metal interactions may take place between one Fe—O bond or via one phosphate using two oxygens to chelate a single surface metal ion. Further variation comes from changes with the pH of surrounding water, able to render the surface cationic, neutral, or anionic.⁶⁹ Maintaining steel in air, deionized water, or sea water will also vary the species residing atop the surface including the complications of water versus ions.

Conclusions. In order to be of high performance, good bulk adhesives require strong bonding to surfaces, formidable cohesive interactions, and a good balance between these forces such that one type does not outweigh the other to create any major weakness. Although binding adhesives to metals is rather complex, we did receive a helpful insight here. Phosphate groups in the polymer have the ability to enhance surface interactions. When viewed after adhesive curing, phosphates exhibited an exceptional ability to enhance surface attachment of these polymers. Sufficient cohesion may have been achieved by oxidative cross-linking between polymer chains that resulted from having catechols present.

All told, surface adhesive and bulk cohesive interactions brought poly(catechol-phosphate) to a point of approaching the performance of established commercial glues. Phosphates increased dry adhesion to being near that of glues made from polyurethanes and polyvinyl acetates. Underwater adhesion was also observed, albeit significantly weaker than dry conditions. Given that phosphates helped to impart some enhancements to underwater performance, we do wonder if these groups contributed to drying or dewetting of surfaces, thereby improving the ability of a polymer to make contact. Perhaps double hydrogen bonding or chelation at the interface release bound waters or ions to generate an entropically favorable event.⁷⁰

We began this study wondering why sea stars, mussels, and sandcastle worms go through such effort to phosphorylate their proteins. Here we have seen that the unique ability of these animals to stick underwater may be aided, somewhat, by phosphorylation. The differences seen were not as stark as adhesion with phosphate versus no bonding without phosphate. Rather, a modest enhancement of both dry and wet adhesion was noted with increasing phosphate loadings. By contrast, polymers with pendant catechol groups have been shown to exhibit significantly higher adhesion than analogous polymers without catechol. Thus phosphate groups may be present to aid the dewetting, surface attachment, and overall adhesive behavior of catechol-containing proteins and polymers. Perhaps such insights will facilitate our ability to design even higher performance materials for future bonding in challenging environments.

### Experimental Section

Materials. Methyl methacrylate (MMA), anhydrous methanol, and 2,2′-azobis(2-methylpropionitrile) (AIBN) were purchased from Sigma-Aldrich. Methanol crystallization was used to purify AIBN. Dopamine methacrylamide (DMA) was made according to a previously reported procedure.⁴³ Monoacryloxyethyl phosphate (MAEP) was purchased from Polysciences (400 Valley Rd, Warrington, PA 18976). Commercial MAEP comes with a diester impurity and was purified through hexane and methanol extractions.^{5, 7, 38, 44} Literature reports have shown that most sources of MAEP contain this diester impurity, left over from the synthesis.⁴⁴ The diester tends not to be a major issue for some applications such as dental work. However, when used here with radical polymerizations, unwanted cross-linking and gelation during syntheses were observed.^{24, 45, 46} Purification of the monoester with extractions helped to obtain the target polymers.

Characterization. Polymers were characterized primarily with ¹H and ³¹P nuclear magnetic resonance (NMR) spectroscopies and gel permeation chromatography (GPC). The GPC data were acquired on an Agilent 1260 Infinity II system. The ¹H and ³¹P NMR spectra were recorded on a Varian Inova-300 MHz spectrometer. Deionized water was prepared using a Barnstead Nanopure Infinity Ultrapure water system with a final resistivity of 18.2 MΩ. Artificial seawater was prepared from Marine Environment dual phase formula dissolved into reverse osmosis purified water to a final salinity of 32 g/L.

Synthesis of poly[N-(3,4-dihydroxyphenethyl)methacrylamide)-co-methyl methacrylate-co-(monoacryloxy ethyl phosphate)], “poly(catechol-phosphate)”. Synthesis of poly(catechol-phosphate) was carried out using a feed ratio of 2.55 mmol DMA (dopamine methacrylamide), 5.63 mmol MMA (methyl methacrylate), and 1.35 mmol monoacryloxyethyl phosphate (MAEP). The monomer ratio was kept constant for all syntheses. Dry Schlenk methods were used with a 125 mL flask that had been flame dried three times into which 25 mL of anhydrous methanol was added. Methyl methacrylate was placed into the reaction vessel via syringe. Dopamine methacrylamide was massed and dissolved in anhydrous methanol, separately in a 20 ml vial, degassed, and added to the reaction flask. The MAEP monomer is extremely viscous at storage temperature (−22° C.) and was raised to room temperature before adding to the reaction vessel by syringe. The AIBN radical initiator was added at 5 mole percent after being dissolved in 2 mL of degassed methanol. The initiator amount would be increased by 5 mole percent for every additional 25 mL of methanol solvent to ensure polymerization would occur. With the catechol and phosphate monomers requiring methanol for solubility, excess AIBN was needed to counteract the radical scavenging effects of hydroxyls and catechols.⁴⁷⁻⁴⁹ The AIBN was dissolved into anhydrous methanol and added once the reaction vessel attained 60° C. Polymerizations progressed under argon at 60° C. for 24 hr. Cold diethyl ether (˜25 mL) was added to the polymer mixture and placed in a −22° C. freezer overnight. The resulting yellow precipitate was separated from the solution via decanting, dried with rotary evaporation, and further dried under vacuum for 24-72 hr. If monomer impurities persisted, evidenced by ¹H NMR spectra, the polymer was washed by dissolving in methanol and precipitating with cold diethyl ether several times.

The GPC data for each polymer are provided in Table 1. Calibration was via six external polystyrene standards purchased from Agilent Technologies. ¹H NMR (300 Hz, CD₃OD-d⁴, δ): 0.75-1.13 (broad, polymer backbone, CH₂CH), 1.73-2.14 (broad, methyl, carbon backbone, CHCH₃), 2.56-2.76 (broad, methylene nearest to aromatic group, CH₂CH₂) 3.21-3.35 (broad, s, methylene farthest from aromatic group, CH₂CH₂) 3.96-4.41 (broad, combination of methylene peaks, CH₂CH₂OPO(OH)₂), 6.50-6.81 (broad, aromatic) ³¹P NMR (202 Hz, CD₃OD-d4, δ): 4.73 (singlet, CH₂CH₂OPO(OH)₂).^{50, 51} Representative characterization data are provided in the Supporting Information section. FIGS. 5A-5B show ¹H (5A) and ³¹P (5B) NMR spectra for a polymer with 17% phosphate monomers. The analogous ¹H NMR spectrum for the control polymer, without phosphate, is in FIG. 6. A GPC trace for the 17% phosphate polymer is carried out to confirm the molecular weights.

Contact Angles. Solutions of polymer in methanol were dropped from a syringe (˜5 mL) onto stainless steel or Teflon substrates. Images were taken with a Nikon D750 camera fitted with an extension tube and a 50 mm lens. CircuDyn software was used to extract values from the images. Each contact angle provided is an average of 5 samples and showing errors via 90% confidence intervals.

Adhesion Methodology. Adhesion was measured with an Instron 5544 materials testing system. Experience has shown that lap shear bond configurations make for a consistent and relatable method of quantifying the performance of new polymer systems, especially when large quantities of samples need to be examined.^{17, 18, 21} Substrates were 304 SAE grade stainless steel of 0.2 cm thickness. These sheets were purchased pre-cut from Nuclear Alloys. The substrates were triple rinsed with hexane, acetone, and methanol prior to use. Substrates had dimensions of 1.2 cm×8.8 cm and a hole for a pin was 0.6 cm in diameter and 1 cm from one end. This hole was used to place the pin into each substrate and pull the joint apart until failure. Lap shear joints were formed with 1.2×1.2 cm overlap area between substrates.

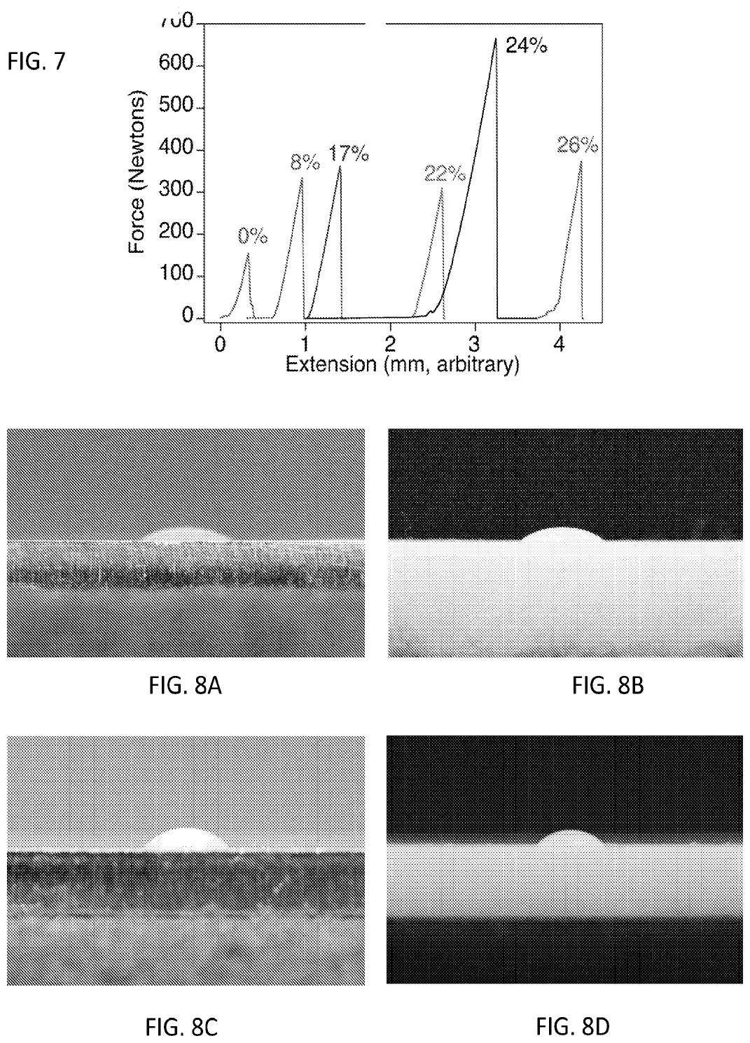

Polymer solutions were formulated to be 0.3 g/mL in methanol. The cross-linker, used here to oxidize catechol groups, was tetrabutylammonium periodate, [(C₄H₉)₄N](IO₄). This reagent was dissolved into methanol at a concentration of 0.3 g/mL with the catechol to cross-linker ratio starting out at 3:1, which has been shown, in prior studies, to work well.^{18, 21, 52} Ultimately, a ratio of 4:1 was used due to the nature of the cross-linked gel poly(catechol-phosphate) formed and the increase in wetting. Polymer solutions at 20 μL and 5 μL of the cross-linker solution were placed atop the steel substrates over the 1.2 cm×1.2 cm overlap area. The second substrate was then overlapped onto the first to form a lap shear joint. The assemblies stood at room temperature for 1 hour and then were placed into a 70° C. oven. After 22 hours in the oven, the joints were removed and cooled for one hour at room temperature. These joints were then mounted into the materials testing system, held in place with two pins, each placed through the holes at the substrates ends. Joints were pulled apart at 2 mm/min, while measuring force, until failure. FIG. 7 shows representative plots for each polymer. Adhesion was calculated in Pascals by taking the maximum force observed divided by the overlap area (N/m²). These procedures were a modification of the ASTM D1002 standard method.^{53, 54} Each data point was averaged from a minimum of 5 samples. Error bars shown are 90% confidence intervals.

Those skilled in the art will recognize that numerous modifications can be made to the specific implementations described above. The implementations should not be limited to the particular limitations described. Other implementations may be possible.

While the inventions have been illustrated and described in detail in the drawings and foregoing description, the same is to be considered as illustrative and not restrictive in character, it being understood that only certain embodiments have been shown and described and that all changes and modifications that come within the spirit of the invention are desired to be protected. It is intended that the scope of the present methods and apparatuses be defined by the following claims. However, it must be understood that this disclosure may be practiced otherwise than is specifically explained and illustrated without departing from its spirit or scope. It should be understood by those skilled in the art that various alternatives to the embodiments described herein may be employed in practicing the claims without departing from the spirit and scope as defined in the following claims.

### REFERENCES CITED

(1) Flammang, P.; Lambert, A.; Bailly, P.; Hennebert, E., Polyphosphoprotein-Containing Marine Adhesives. J. Adhes. 2009, 85, 447-464.
(2) Kaur, S.; Weerasekare, G. M.; Stewart, R. J., Multiphase Adhesive Coacervates Inspired by the Sandcastle Worm. ACS Appl. Mater. Interfaces 2011, 3, 941-944.
(3) Kim, H. J.; Yang, B.; Park, T. Y.; Lim, S.; Cha, H. J. Y., Complex Coacervates Based on Recombinant Mussel Adhesive Proteins: their Characterization and Applications. Soft Matter 2017, 13, 7704-7716.
(4) A. Li, M. Jia, Y. Mu, W. Jiang, X. Wan, Humid Bonding with a Water-Soluble Adhesive Inspired by Mussels and Sandcastle Worms. Macromol. Chem. Phys. 2015, 216, 450-459.
(5) Shao, H.; Bachus, K. N.; Stewart, R. J., A Water-borne Adhesive Modeled after the Sandcastle Glue of P. californica. Macromol. Biosci 2009, 9, 464-471.
(6) Song, I. T.; Stewart, R. J., Complex Coacervation of Mg(ii) Phospho-Polymethacrylate, a Synthetic Analog of Sandcastle Worm Adhesive Phosphoproteins. Soft Matter 2018, 14, 379-386.
(7) Stewart, R.; Weaver, J.; Morse, D.; Waite, J., The Tube Cement of Phragmatopoma californica: A Solid Foam. J. Exp. Biol. 2005, 207, 4727-34.
(8) Waite, J. H., Mussel Adhesion—Essential Footwork. J. Exp. Biol. 2017, 220, 517.
(9) Hwang, D. S.; Waite, J. H., Three Intrinsically Unstructured Mussel Adhesive Proteins, Mfp-1, Mfp-2, and Mfp-3: Analysis by Circular Dichroism. Protein Sci. 2012, 21, 1689-1695.
(10) Silverman, H. G.; Roberto, F. F., Understanding Marine Mussel Adhesion. Mar. Biotechnol. 2007, 9, 661-681.
(11) Zhao, H.; Waite, J. H., Linking Adhesive and Structural Proteins in the Attachment Plaque of Mytilus californianus. J. Biol. Chem. 2006, 281, 26150-26158.
(12) Filpula, D. R.; Lee, S.-M.; Link, R. P.; Strausberg, S. L.; Strausberg, R. L., Structural and Functional Repetition in a Marine Mussel Adhesive Protein. Biotechnol. Prog. 1990, 6, 171-177.
(13) Rzepecki, L. M.; Hansen, K. M.; Waite, J. H., Characterization of a Cystine-Rich Polyphenolic Protein Family from the Blue Mussel Mytilus edulis L. Biol. Bull. 1992, 183, 123-137.
(14) Zhao, H.; Waite, J. H., Proteins in Load-Bearing Junctions: The Histidine-Rich Metal-Binding Protein of Mussel Byssus. Biochemistry 2006, 45, 14223-14231.
(15) Long, J. R.; Dindot, J. L.; Zebroski, H.; Kiihne, S.; Clark, R. H.; Campbell, A. A.; Stayton, P. S.; Drobny, G. P., A Peptide that Inhibits Hydroxyapatite Growth is in an Extended Conformation on the Crystal Surface. Proc. Natl. Acad. Sci. U.S.A. 1998, 95, 12083-12087.
(16) Mu, Y.; Wu, X.; Pei, D.; Wu, Z.; Zhang, C.; Zhou, D.; Wan, X., Contribution of the Polarity of Mussel-Inspired Adhesives in the Realization of Strong Underwater Bonding. ACS Biomater. Sci. Eng. 2017, 3, 3133-3140.
(17) North, M. A.; Del Grosso, C. A.; Wilker, J. J., High Strength Underwater Bonding with Polymer Mimics of Mussel Adhesive Proteins. ACS Appl. Mater. Interfaces 2017, 9, 7866-7872.
(18) Jenkins, C. L.; Meredith, H. J.; Wilker, J. J., Molecular Weight Effects upon the Adhesive Bonding of a Mussel Mimetic Polymer. ACS Appl. Mater. Interfaces 2013, 5, 5091-5096.
(19) Lee, S.-B.; Gonzalez-Cabezas, C.; Kim, K.-M.; Kim, K.-N.; Kuroda, K., Catechol-Functionalized Synthetic Polymer as a Dental Adhesive to Contaminated Dentin Surface for a Composite Restoration. Biomacromolecules 2015, 16, 2265-2275.
(20) Matos-Pérez, C. R.; White, J. D.; Wilker, J. J., Polymer Composition and Substrate Influences on the Adhesive Bonding of a Biomimetic, Cross-Linking Polymer. J. Am. Chem. Soc. 2012, 134, 9498-9505.
(21) Jenkins, C. L.; Meredith, H. J.; Wilker, J. J., Enhancing the Adhesion of a Biomimetic Polymer Yields Performance Rivaling Commercial Glues. Adv. Funct. Mater. 2014, 24, 3259-3267.
(22) Lee, B. P.; Messersmith, P. B.; Israelachvili, J. N.; Waite, J. H., Mussel-Inspired Adhesives and Coatings. Annu. Rev. Mater. Sci. 2011, 41, 99-132.
(23) Xu, Y.; Liu, Q.; Narayanan, A.; Jain, D.; Dhinojwala, A.; Joy, A., Mussel-Inspired Polyesters with Aliphatic Pendant Groups Demonstrate the Importance of Hydrophobicity in Underwater Adhesion. Adv. Mater. Interfaces 2017, 4, 1700506.
(24) Suzuki, S.; Whittaker, M. R.; Grøndahl, L.; Monteiro, M. J.; Wentrup-Byrne, E., Synthesis of Soluble Phosphate Polymers by RAFT and their in vitro Mineralization. Biomacromolecules 2006, 7, 3178-3187.
(25) Peng, Y.-F.; Tsai, A.; Huang, M., Synthesis and Thermal Investigation of Phosphate-Functionalized Acrylic Materials. Polym. J. 2018, 50, 967-974.
(26) Boutevin, B.; Hamoui, B.; Parisi, J. P., Synthesis and Polymerizations of Monomers Bearing Phosphonated Groups. I. Applications on Acrylates and Methacrylates. J. Appl. Polym. Sci. 1994, 52, 449-456.
(27) Forooshani, P. K.; Lee, B. P., Recent Approaches in Designing Bioadhesive Materials Inspired by Mussel Adhesive Protein. J. Polym. Sci. A Polym. Chem. 2017, 55, 9-33.
(28) Zhao, H.; Robertson, N. B.; Jewhurst, S. A.; Waite, J. H., Probing the Adhesive Footprints of Mytilus californianus Byssus. J. Biol. Chem. 2006, 281, 11090-11096.
(29) Rapp, M. V.; Maier, G. P.; Dobbs, H. A.; Higdon, N. J.; Waite, J. H.; Butler, A.; Israelachvili, J. N., Defining the Catechol—Cation Synergy for Enhanced Wet Adhesion to Mineral Surfaces. J. Am. Chem. Soc. 2016, 138, 9013-9016.
(30) White, J. D.; Wilker, J. J., Underwater Bonding with Charged Polymer Mimics of Marine Mussel Adhesive Proteins. Macromolecules 2011, 44, 5085-5088.
(31) Lu, Q.; Oh, D. X.; Lee, Y.; Jho, Y.; Hwang, D. S.; Zeng, H., Nanomechanics of Cation-π Interactions in Aqueous Solution. Angew. Chem. Int. Ed. 2013, 52, 3944-3948.
(32) Hwang, D. S.; Zeng, H.; Srivastava, A.; Krogstad, D. V.; Tirrell, M.; Israelachvili, J. N.; Waite, J. H., Viscosity and Interfacial Properties in a Mussel-inspired Adhesive Coacervate. Soft Matter 2010, 6, 3232-3236.
(33) Gallivan, J. P.; Dougherty, D. A., A Computational Study of Cation—π Interactions vs Salt Bridges in Aqueous Media: Implications for Protein Engineering. J. Am. Chem. Soc. 2000, 122, 870-874.
(34) Hofman, A. H.; van Hees, I. A.; Yang, J.; Kamperman, M., Bioinspired Underwater Adhesives by Using the Supramolecular Toolbox. Adv. Mater. 2018, 30, 1704640.
(35) Wang, C. S.; Stewart, R. J., Localization of the Bioadhesive Precursors of the Sandcastle Worm, Phragmatopoma californica. J. Exp. Biol. 2012, 215, 351-361.
(36) Jensen, R. A.; Morse, D. E., The Bioadhesive of Phragmatopoma californica Tubes: a Silk-Like Cement Containing L-DOPA. J. Comp. Physiol. B 1988, 158, 317-324.
(37) Wei, W.; Tan, Y.; Martinez Rodriguez, N. R.; Yu, J.; Israelachvili, J. N.; Waite, J. H., A Mussel-Derived one Component Adhesive Coacervate. Acta Biomater. 2014, 10, 1663-1670.
(38) Stewart, R. J.; Ransom, T. C.; Hlady, V., Natural Underwater Adhesives. J. Polym. Sci. B Polym. Phys. 2011, 49, 757-771.
(39) Sanghera, J. S.; Paddon, H. B.; Pelech, S. L., Role of Protein Phosphorylation in the Maturation-Induced Activation of a Myelin Basic Protein Kinase from Sea Star Oocytes. J. Biol. Chem. 1991, 266, 6700-6707.
(40) Van Wazer, J. R.; Callis, C. F., Metal Complexing By Phosphates. Chem. Rev. 1958, 58, 1011-1046.
(41) Q. Wu, R. A. Weiss, Synthesis and Characterization of Poly(Styrene-co-Vinyl Phosphonate) Ionomers. J. Polym. Sci. B Polym. Phys. 2004, 42, 3628-3641.
(42) Wentrup-Byrne, E.; Suzuki, S.; Grondahl, L., Chapter 9 Biomedical Applications of Phosphorus-Containing Polymers. In Phosphorus-Based Polymers: From Synthesis to Applications, Royal Soc. Chem. 2014; pp 167-209.
(43) Lee, H.; Lee, B. P.; Messersmith, P. B., A Reversible Wet/Dry Adhesive Inspired by Mussels and Geckos. Nature 2007, 448, 338-341.
(44) Grøndahl, L.; Suzuki, S.; Wentrup-Byrne, E., Influence of a Diene Impurity on the Molecular Structure of Phosphate-Containing Polymers with Medical Applications. Chem Comm 2008, 3314-3316.
(45) Moszner, N.; Catel, Y., Chapter 8 Phosphorus-Based Monomers Used for Dental Application. In Phosphorus-Based Polymers: From Synthesis to Applications, Royal Soc. Chem. 2014; pp 151-166.
(46) Stancu, I. C.; Filmon, R.; Cincu, C.; Marculescu, B.; Zaharia, C.; Tourmen, Y.; Baslé, M. F.; Chappard, D., Synthesis of Methacryloyloxyethyl Phosphate Copolymers and in vitro Calcification Capacity. Biomaterials 2004, 25, 205-213.
(47) Avci, D.; Mathias, L. J., Synthesis and Polymerization of Phosphorus-Containing Acrylates. J. Polym. Sci. A Polym. Chem. 2002, 40, 3221-3231.
(48) Monge, S.; Canniccioni, B.; David, G.; Robin, J.-J., Chapter 1 Polymerization of Phosphorus-Containing (Meth)acrylate Monomers. In Phosphorus-Based Polymers: From Synthesis to Applications, Royal Soc. Chem. 2014; pp 1-18.
(49) Monge, S.; Graillot, A.; Robin, J.-J., CHAPTER 2 Polymerization of Phosphorus-Containing (meth)acrylamide Monomers. In Phosphorus-Based Polymers: From Synthesis to Applications, Royal Soc. Chem. 2014; pp 19-34.
(50) D. Quin, L.; Williams, A., Practical Interpretation of P-31 NMR Spectra and Computer-Assisted Structure Verification. Adv. Chem. Devel. 2004 44, 1-40.
(51) Komber, H.; Steinert, V.; Voit, B., H, 13C, and 31P NMR Study on Poly(vinylphosphonic acid) and Its Dimethyl Ester. Macromolecules 2008, 41, 2119-2125.
(52) Sever, M. J.; Weisser, J. T.; Monahan, J.; Srinivasan, S.; Wilker, J. J., Metal-Mediated Cross-Linking in the Generation of a Marine-Mussel Adhesive. Angew. Chem. 2004, 43, 448-450.
(53) Westwood, G.; Horton, T. N.; Wilker, J. J., Simplified Polymer Mimics of Cross-Linking Adhesive Proteins. Macromolecules 2007, 40, 3960-3964.
(54) ASTM D1002-10(2019), Standard Test Method for Apparent Shear Strength of Single-Lap-Joint Adhesively Bonded Metal Specimens by Tension Loading (Metal-to-Metal), ASTM International, West Conshohocken, P A, 2019.
(55) Khwaja, T. A.; Reese, C. B.; Stewart, J. C. M., A Convenient General Procedure for the Conversion of Alcohols into their Monophosphate Esters. J. Chem. Soc. 1970, 2092-2100.
(56) Barth, A. P.; Tormena, C. F.; Viotto, W. H., pH Influences Hydrolysis of Sodium Polyphosphate in Dairy Matrices and the Structure of Processed Cheese. J. Dairy Sci. 2017, 100, 8735-8743.
(57) J Cohen, R.; Fox, D.; Eubank, J.; Salvatore, R., Mild and Efficient Cs₂CO₃-Promoted Synthesis of Phosphonates. Tetrahedron Lett. 2004, 44, 8617-8621.
(58) Rajeshwaran, G. G.; Nandakumar, M.; Sureshbabu, R.; Mohanakrishnan, A. K., Lewis Acid-Mediated Michaelis-Arbuzov Reaction at Room Temperature: A Facile Preparation of Arylmethyl/Heteroarylmethyl Phosphonates. Org. Lett. 2011, 13, 1270-1273.
(59) David, G.; Negrell, C.; Manseri, A.; Boutevin, B., Poly(MMA)-b-Poly(monophosphonic acrylate) Diblock Copolymers Obtained by ATRP and Used as Additives for Anticorrosive Coatings. J. Appl. Polym. Sci 2009, 114, 2213-2220.
(60) Taguchi, K.; Inaba, T.; Takeuchi, Y., The Effect of Acid Phosphate Compounds on Adhesion Properties of Acrylic Adhesives. J. Phys. Soc. Jpn. 2000, 36, 136-143.
(61) Odian, G., Chain Copolymerization. Principles of Polymerization 2004, 464-543.
(62) Barclay, L. R. C.; Edwards, C. E.; Vinqvist, M. R., Media Effects on Antioxidant Activities of Phenols and Catechols. J. Am. Chem. Soc. 1999, 121, 6226-6231.
(63) Matos-Pérez, C. R.; Wilker, J. J., Ambivalent Adhesives: Combining Biomimetic Cross-Linking with Antiadhesive Oligo (ethylene glycol). Macromolecules 2012, 45, 6634-6639.
(64) Lee, B. P.; Dalsin, J. L.; Messersmith, P. B., Synthesis and Gelation of DOPA-Modified Poly(ethylene glycol) Hydrogels. Biomacromolecules 2002, 3, 1038-1047.
(65) Shao, H.; Weerasekare, G. M.; Stewart, R. J., Controlled Curing of Adhesive Complex Coacervates with Reversible Periodate Carbohydrate Complexes. J. Biomed. Mater. Res. A 2011, 97A, 46-51.
(66) Shao, H.; Stewart, R. J., Biomimetic Underwater Adhesives with Environmentally Triggered Setting Mechanisms. Adv. Mater. 2010, 22, 729-733.
(67) Li, M.; Liu, J.; Xu, Y.; Qian, G., Phosphate Adsorption on Metal Oxides and Metal Hydroxides: A Comparative Review. Environ. Rev. 2016, 24, 319-332.
(68) Farley, K. J.; Dzombak, D. A.; Morel, F. M. M., A Surface Precipitation Model for the Sorption of Cations on Metal Oxides. J. Colloid Interface Sci. 1985, 106, 226-242.
(69) Spiteri, C.; Regnier, P.; Slomp, C. P.; Charette, M. A., pH-Dependent Iron Oxide Precipitation in a Subterranean Estuary. J. Geochem. Explor. 2006, 88, 399-403.
(70) Mian, S. A.; Yang, L.-M.; Saha, L. C.; Ahmed, E.; Ajmal, M.; Ganz, E., A Fundamental Understanding of Catechol and Water Adsorption on a Hydrophilic Silica Surface: Exploring the Underwater Adhesion Mechanism of Mussels on an Atomic Scale. Langmuir 2014, 30, 6906-6914.

1. A method for increasing surface wetting capability of a biomimetic polymer adhesive, wherein the biomimetic polymer adhesive is in a solution form comprising a catechol-containing polymer or co-polymer comprising the step of introducing a plurality of phosphate moieties into said biomimetic polymer adhesive.

2. (canceled)

3. The method of claim 1, wherein said plurality of phosphate moieties are introduced into said biomimetic polymer adhesive by way of copolymerization of monoacryloxyethyl phosphate (MAEP) together with other monomers.

4. The method of claim 1, wherein said plurality of phosphate moieties are introduced into said biomimetic polymer adhesive by way of chemical derivatization of a polymer or copolymer.

5. (canceled)

6. (canceled)

7. The method of claim 1, wherein said plurality of phosphate moieties accounts for from about 0.1% to about 50% of the whole copolymer.

8. A biomimetic polymer adhesive having an increased surface wetting capability, wherein said biomimetic polymer adhesive is in a solution form comprising a catechol-containing polymer or co-polymer with a plurality of phosphate moieties.

9. The biomimetic polymer adhesive having an increased surface wetting capability according to claim 8, wherein said plurality of phosphate moieties accounts for from about 0.1% to about 50% of the total biomimetic polymer adhesive.

10. (canceled)

11. The biomimetic polymer adhesive having an increased surface wetting capability according to claim 8, wherein said plurality of phosphate moieties are introduced into said biomimetic polymer adhesive by way of copolymerization of monoacryloxyethyl phosphate (MAEP) with other monomers.

12. The biomimetic polymer adhesive having an increased surface wetting capability according to claim 8, wherein said biomimetic polymer adhesive is used for dry bonding or underwater wet bonding.

13. The biomimetic polymer adhesive having an increased surface wetting capability according to claim 8, wherein said biomimetic polymer adhesive is used for bonding on a metal surface.

14. The biomimetic polymer adhesive having an increased surface wetting capability according to claim 8, wherein said biomimetic polymer adhesive is used as a paint, surface coating, or a primer.

15. (canceled)

16. A biomimetic copolymer adhesive having an increased wetting capability, wherein the biomimetic polymer adhesive is in a solution form, manufactured according to the steps of
a) mixing catechol containing DMA (dopamine methacrylamide), MMA (methyl methacrylate), and monoacryloxyethyl phosphate monomers in a solvent to give a mixture;
b) adding an initiator of polymerization to the mixture under a constant stirring to trigger said polymerization;
c) quenching said polymerization; and
d) removing said solvent to afford said biomimetic copolymer adhesive having an increased wetting capability.

17. The biomimetic copolymer adhesive having an increased wetting capability according to claim 16, wherein said monomers have a molar ratio of about 3:6:1.

18. The biomimetic polymer adhesive having an increased surface wetting capability according to claim 16, wherein said biomimetic polymer adhesive is used for dry bonding or underwater wet bonding.

19. The biomimetic polymer adhesive having an increased surface wetting capability according to claim 16, wherein said biomimetic polymer adhesive is used for bonding on a metal surface.

20. The biomimetic polymer adhesive having an increased surface wetting capability according to claim 16, wherein said plurality of phosphate moieties accounts for from about 0.1% to about 50% of the whole copolymer.

21. The biomimetic polymer adhesive having an increased surface wetting capability according to claim 16, wherein said biomimetic polymer adhesive is used as a paint, surface coating, or a primer.

22. (canceled)
